(19) United States
(12) Patent Application Publication
(10) Pub. No.: US 2010/0026070 A1
(43) Pub. Date: Feb. 4, 2010

(54) Runner and Seat Provided with a Locking System

(76) Inventors: Rene Rohee, La Chapelle Biche (FR); Francois Baloche, La Carneille (FR)

Correspondence Address: MILLER, MATTHIAS & HULL, ONE NORTH FRANKLIN STREET, SUITE 2350, CHICAGO, IL, 60606, US

(21) Appl. No.: 12/518,238

(22) PCT Filed: Dec. 12, 2007
(86) PCT No.: PCT/FR07/52494

§ 371 Date: Jun. 8, 2009

(30) Foreign Application Priority Data
Dec. 20, 2006 (FR) 06 11138

(51) Int. Cl. B60N 2/08; B60N 2/06; B60N 2/07; B60N 2/12

(52) U.S. Cl. 297/344.1; 248/429; 296/65.13

(57) ABSTRACT

The runner comprises a mechanical locking system and a memorization system, comprising: a locking bar, a locking device that is movable between a normal position and a locking position in which it cooperates with the locking bar, an electromagnetic actuator that moves the locking device to its locking position when it receives a command from a control device.

The present invention relates to the runners and seats of motor vehicles provided with locking systems.

In particular, the invention relates to a motor vehicle seat runner comprising:
a fixed profile adapted to be fixed to a floor of a motor vehicle,
a movable profile adapted to be fixed to a vehicle seat element that is adapted to receive an occupant, said movable profile being complementary to the fixed profile and movably mounted in relation to the latter in a direction of sliding,
a mechanical locking system of the fixed profile and the movable profile, adapted to alternately adopt an active state in which it prevents the relative movement of said fixed and movable profiles, and an idle state in which it allows said relative movement,
a control device of the mechanical locking system, said control device being adapted to move said mechanical locking system from its active state to its idle state, and
a position memorization system, adapted to prevent the movement of the movable profile beyond a predetermined position when the mechanical locking system is in its idle state.

Such locking systems are for example known from FR 2,695,885. Although such runners are fully satisfactory, there is a need to provide variants of such runners, for example in order to provide seat runners having memorization systems suitable for runners having novel functionalities.

There is also a need to provide a runner that is simple to assemble and involves robust and proven components.

To this end, according to the invention, a runner of the type in question is characterized in that the memorization system comprises:
a locking bar comprising a set of locking reliefs spaced apart in a longitudinal direction, said bar being integral with the fixed profile,
a locking device movably mounted on the movable profile, between a rest position in which it does not cooperate with any of the locking reliefs in order to allow movement longitudinal direction, and a relative locked position of the movable profile and the fixed profile along the in which it cooperates with a locking relief to prevent said relative movement,
a electromagnetic actuator fixed to the movable profile, and adapted to move the locking device to its locked position upon receipt of an actuation command,
a control device electrically connected to said actuator, and adapted to transmit an actuation command to the actuator in order to prevent the relative movement of the movable profile and the fixed profile beyond said predetermined position.

Through these arrangements, an electromagnetic memorization system is used. Such a memorization system can therefore be used in runners that are already provided with an electrical function.

In preferred embodiments of the invention it is also possible, optionally, to make use of one and/or another of the following arrangements:
the control device comprises a position detection system adapted to detect a relative position of the fixed profile and the movable profile in the longitudinal direction, said position detection system being electrically connected to the actuator, the control device being adapted to transmit an actuation command to the actuator when it detects said predetermined relative position;
the detection system comprises at least one tracking element, fixed to the fixed profile, and a position sensor adapted to detect said tracking element and to transmit a signal related to said tracking element;
the runner comprises a plurality of separate tracking elements spaced apart in said longitudinal direction, the control device comprising a programmable memory comprising position personalization information, the control device comprising a central processing unit adapted to compare said signals with said position personalization information and to transmit said actuation command upon positive result of said comparison;
the actuator is adapted to move the locking device to its locked position for a period of less than five seconds upon receipt of an actuation command, the actuator comprising a mechanical biasing device adapted to move the locking device to its rest position after said period;
the runner comprises an adjustment system for adjusting said predetermined position.

According to another aspect, the invention relates to a motor vehicle seat comprising:
a seat proper,
a seatback, mounted rotatably in relation to the seat proper about a transverse axis at least between a nominal position and a folded-forward position,
a tilt lock mechanism adapted to selectively adopt an active state in which it prevents rotation of the seatback in relation to the seat proper about the transverse axis, and an idle state in which it allows said rotation,
such a runner, a seat element chosen from the seat proper and the seatback being mounted on the movable profile,
a holding device adapted to maintain the seatback in its folded-forwards position and to maintain said mechanical locking system of the runner in its idle state from at least a forward position of the movable profile to the predetermined position of the movable profile in relation to the fixed profile when the seatback is in said folded-forwards position, said predetermined position being rearward in relation to the forward position,

the actuator being operated in said predetermined position of the movable profile, when the seatback is in said folded-forwards position,

the holding device being adapted to allow the rotation of the seatback in relation to the proper from the folded-forwards position to the nominal position, and to release the mechanical locking system of the runner in order to put it into its active state in said predetermined position.

Other characteristics and advantages of the invention will become apparent during the following description of two of its embodiments, given as a non-limitative example, with reference to the attached drawings.

In the drawings:

FIG. 1 is a diagrammatic side view of a motor vehicle seat,

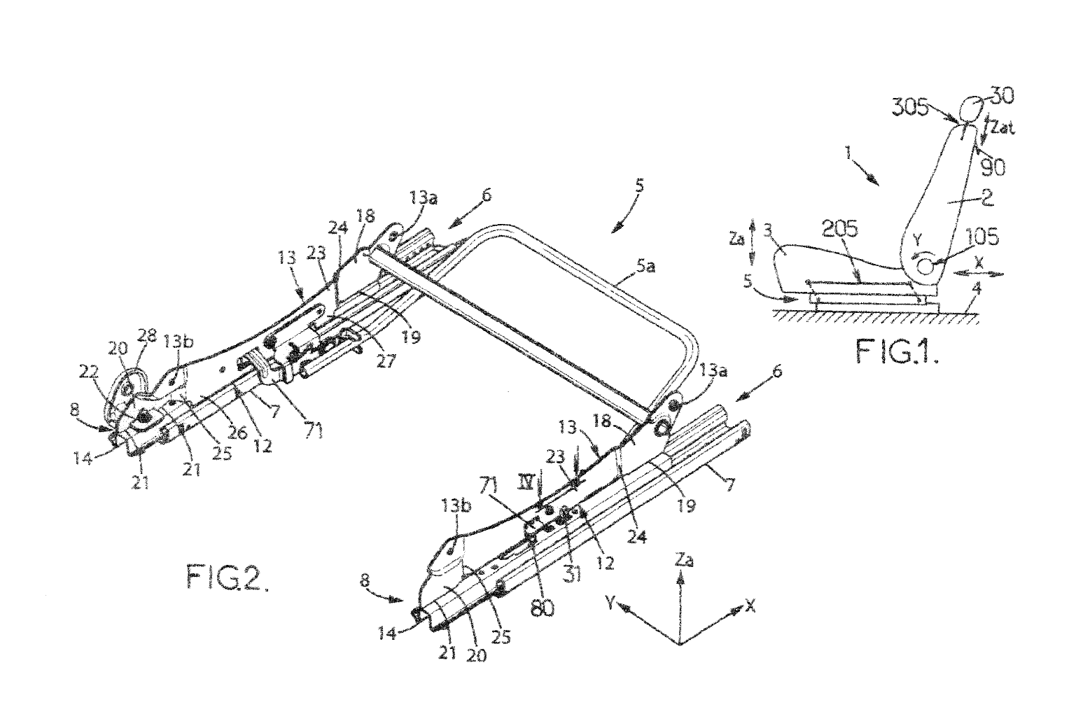

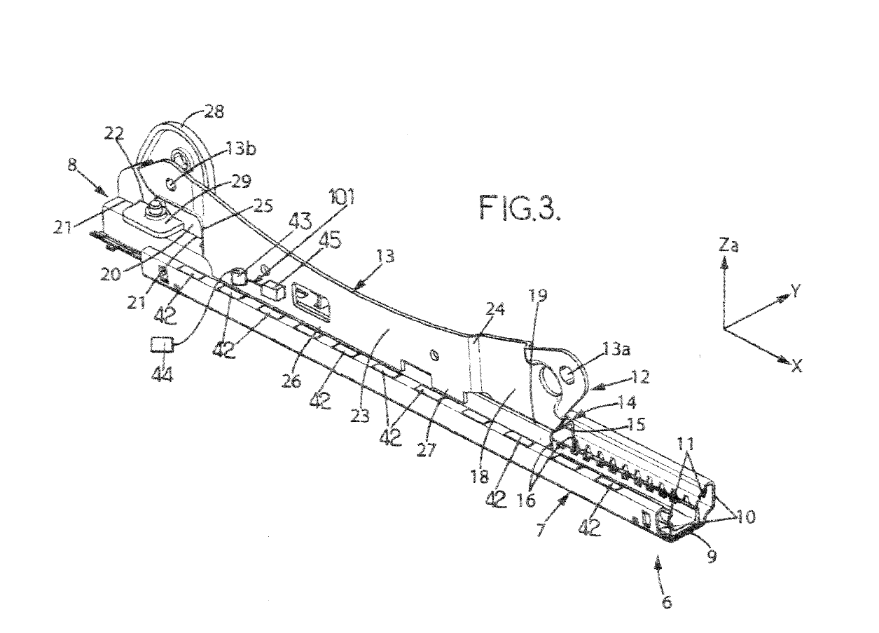

FIG. 2 is a perspective view of a first embodiment of an adjustment mechanism for the seat in FIG. 1,

FIG. 3 is a partial perspective view of the adjustment mechanism in FIG. 2 from an opposite angle,

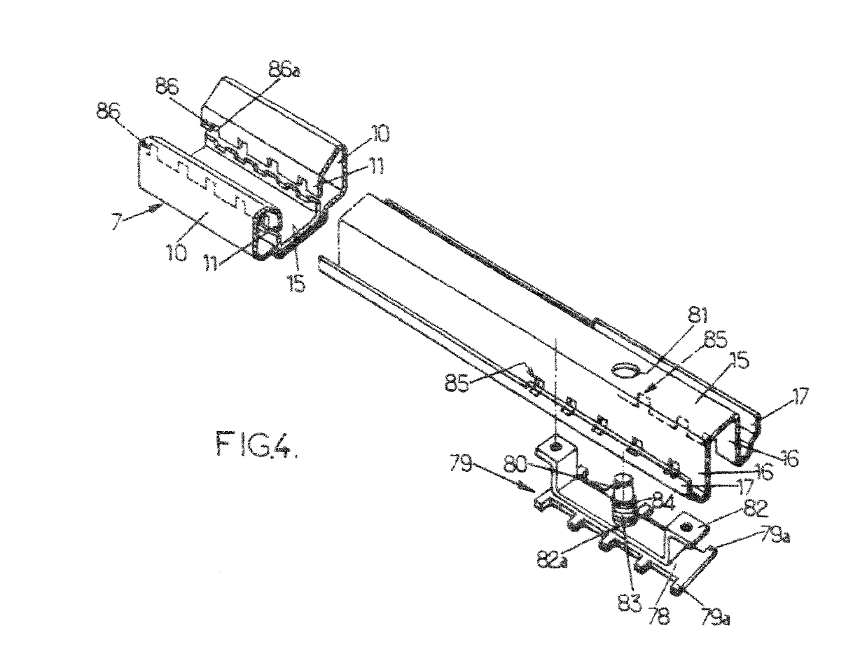

FIG. 4 is an exploded perspective view of an example of a permanent lock for the first embodiment,

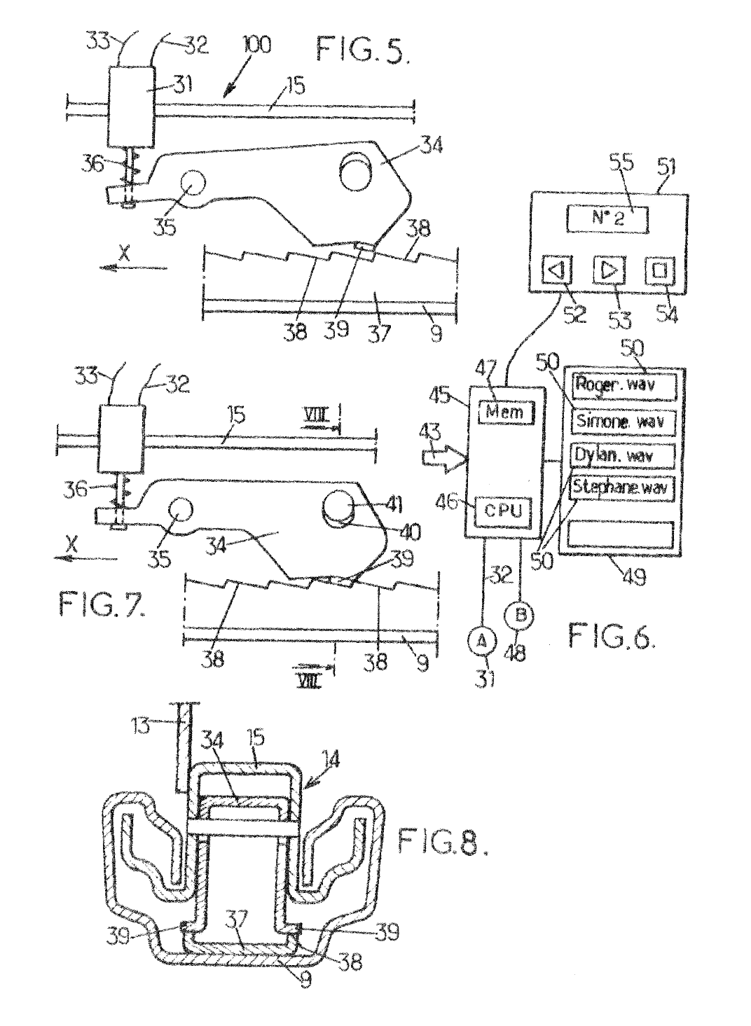

FIG. 5 is a diagrammatic cross-sectional view along the line IV-IV in FIG. 2,

FIG. 6 is a representative diagram of a central processing unit for the first embodiment of an adjustment mechanism,

FIG. 7 is a view corresponding to FIG. 5 in the locked position of the locking element,

FIG. 8 is a cross-sectional diagrammatic view along the line VIII-VIII in FIG. 7,

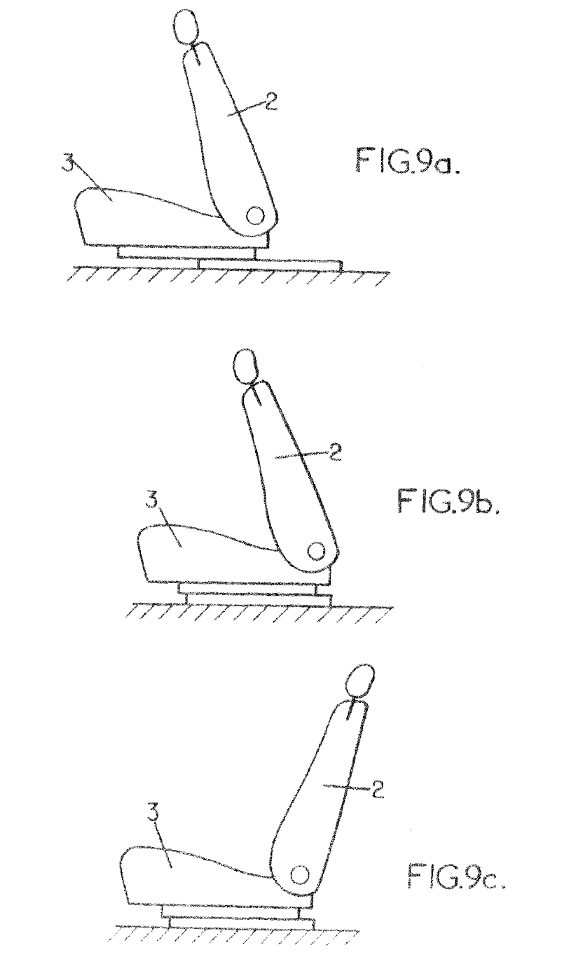

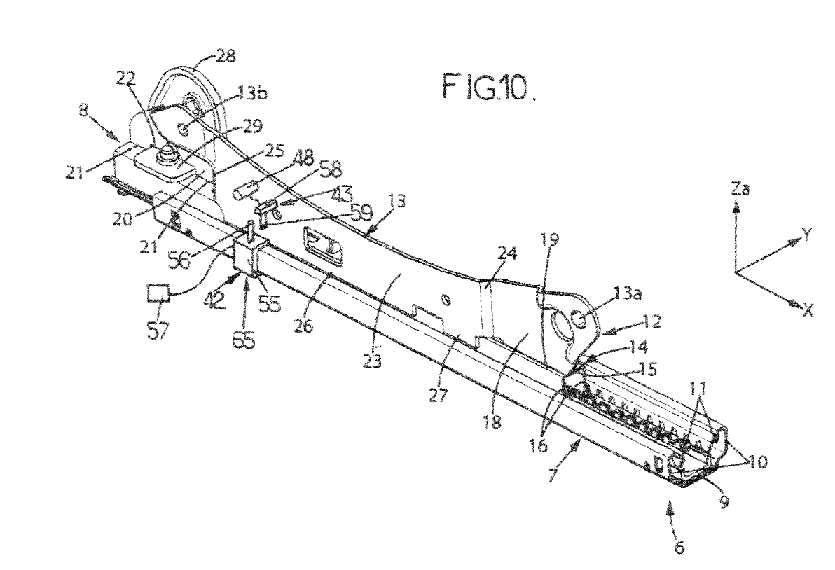

FIGS. 9a, 9b and 9c are three diagrammatic views showing the return of the seat, from its fully-forward position, to its nominal position.

FIG. 10 is a view corresponding to FIG. 3 for a second embodiment.

The same references in different Figures denote identical or similar components.

FIG. 1 shows a motor vehicle seat 1 comprising a seatback 2 supported by a seat proper 3 which is itself slidably mounted on the floor 4 of the vehicle in a longitudinal direction X.

The seat proper 3 is connected to the floor 4 by a longitudinal adjustment mechanism 5 adapted to adjust the relative position of the seat proper in relation to the floor according to a degree of freedom of translation along the axis X. The seat proper 3 is also height adjustable in relation to the floor (in particular in relation to the longitudinal adjustment mechanism) by a mechanism 205 called a “lifting mechanism”. The seatback 2 is mounted rotatably in relation to the seat proper 3 by a tilt adjustment mechanism 105 about the transverse axis Y. Vertical adjustment of the headrest 30 in relation to the top of the seat back is carried out by an adjustment mechanism 305. A control lever 90 is adapted to control the unlocking of the runner and of the seatback on the seat proper, in order to bring the seat forward with the seatback folded forwards.

The longitudinal adjustment mechanism 5 is formed by a set of runners comprising two parallel runners 6, clearly visible in FIG. 2, the unlocking of which is controlled for example by a cross-bar 5a. Each of these runners 6 comprises first and second runner elements 7, 8, which slide, one inside the other, in the direction X. The first runner element 7 can be fixed to the floor 4 of the vehicle. The second runner element 8 can be movable and carry the seat proper 3, for example by means of a lifting mechanism 205 that allows for the height of the seat proper 3 to be adjusted in the direction Za.

As shown in greater detail in FIG. 3, the fixed runner element 7 can for example be in the form of a substantially U-shaped folded and cut sheet metal profile, comprising:
a horizontal base 9 intended to be fixed to the floor 4 of the vehicle,
two vertical side wings 10 extending approximately perpendicular to the base,
and two re-entrant troughs 11 extending the side wings 10 toward the inside of the runner and toward the base 9.

As regards the movable runner element 8, it can comprise:
a sheet metal support 12 comprising an approximately vertical web 13 supporting the seat proper 3 (in the example in question, the web 13 supports the seat proper 3 through the above-mentioned lifting mechanism 205; more particularly, lifting rods 211 belonging to this lifting mechanism can be pivotably mounted in holes 13a, 13b provided in the web 13),
and a folded and cut sheet metal profile 14, substantially in the form of an inverted “U”, which comprises (see FIGS. 3 to 5) a horizontal base plate 15 approximately perpendicular to the web 13 (or more generally forming a non-zero angle with this web), this base plate 15 extending in a transverse direction Y perpendicular to the direction X, between two lateral parts slidably connected to the fixed runner element 7.

In the example considered here, the two lateral parts in question comprise two wings 16 approximately perpendicular to the base plate 15, which extend toward the base 9. These wings 16 are themselves extended outwards, opposite to the base 9, by two upturns 17 that enter the space provided between the lateral wings 10 and the re-entrant troughs 11 of the fixed runner element 7.

Balls (non shown) or other rolling elements are generally placed between the upturns 17 and the lateral wings 10 on the one hand, and between the upturns 17 and the re-entrant troughs 11 on the other hand.

Generally, the shapes of the two runner elements can be similar for example to those described in the document FR-A-2 872 103.

The web 13 of the support 12 comprises two butting portions 18, 20 that extend in two vertical planes parallel to the direction X. These butting portions 18, 20 each have a horizontal lower edge, respectively 19, 21, which abuts the upper face of the base plate 15 of the profile 14 and is butt-welded onto this base plate, for example by laser welding.

In the example in FIG. 3, the lower edge 21 of the butting portion 20 is interrupted locally by a cut-out 22 allowing a tab 29, fixed to the base plate 15 of the movable profile 14, to pass through; this tab 29 belonging to a lug 28 for the attachment of a safety belt anchorage (not shown). In the case of the runner situated on the right-hand side in FIG. 2, the butting portion 20 does not comprise the cut-out 22, so that the lower edge 21 is not interrupted and can thus be welded along its entire length onto the base plate 15.

Of course, the lower edges 19, 21 could optionally be welded onto the base plate 15 in places only, rather than being welded over the whole of their length.

In addition to the butting portions 18, 20, the web 13 of the support 12 also comprises an offset portion 23, which is linked by folds 24, 25 respectively to the butting portions 18, 20, and which is laterally offset in relation to said butting portions. This offset portion 23 extends for example in a plane parallel to the axes X and Z, and is extended downwards by one or more feet 26, 27, extending for example in the same plane as said offset portion 23. As can be seen in FIG. 3, the feet 26, 27 are mounted on one of the lateral wings 16 of the profile 14 and are welded laterally to this wing, for example by laser welding (in particular by welding called laser transparency welding).

As can be seen in FIG. 2, each runner also comprises an actuation device 71 for unlocking the movable profile 14 in relation to the fixed profile 7. This actuation device 71 is controlled by the cross-bar 5a.

In the example shown in FIG. 4, the permanent mechanical locking system 79 comprises a steel plate 78 fixed to the lower end of a control rod 80 that also has an upper end intended to pass through an opening 81 made in the base plate 15 of each movable profile 14 to cooperate with the control device 81. This control rod 80 is slidably mounted in the vertical direction in a through hole 82a of a metal guide 82, itself securely mounted on the base plate 15 of the movable profile 7.

This metal guide 82 supports elastic return means 83 such as a helical spring surrounding the control rod 80 and exerting a force on the plate 78 toward an upper position in which the plate 78 is close to the metal guide 82. To this end, the spring 83 can be placed between the metal guide 82 and a collar 84 produced on the control rod 80.

As can be seen in this FIG. 4, the plate 78 extends approximately parallel to the base plate 15 of the movable profile and comprises a set of teeth 79a at the level of each of its lateral edges.

When the runner is in the assembled state, the set of teeth 79a of the plate 78 extend transversally beyond the vertical wings 16 of the movable profile 14, passing through complementary cut-outs 85 provided in the lower parts of the two vertical wings 16 of the movable profile 14. Moreover, the set of teeth 79a of the plate 78, when they pass through the cut-outs 85, engage respectively in sets of recesses 86a delimited by notches 86 provided on the ends of the troughs 11 of the fixed profile 7, forming the other part of the permanent locking mechanism. These notches 86 produced on the end portions of the troughs 11 are distributed regularly in the longitudinal direction L, thus forming a set of notches having a constant pitch.

As shown in FIGS. 2 to 5, the adjustment mechanism according to the first embodiment also comprises a memorization system implemented in the form of a temporary locking mechanism 100 comprising an actuator 31 mounted in an opening provided to this end in the base plate 15 of the movable profile and comprising an electrical connection device 32 connected to a control system that will be described in greater detail below with respect to FIG. 6, as well as a power supply device 33 connected to an electric generator.

The temporary locking mechanism also comprises a locking device 34 mounted on the movable profile 14, rotatable in relation to the movable profile about a rod 35 between a rest position shown in FIG. 5 and a locked position shown in FIG. 7.

The actuator 31 also comprises a spring 36 pushing the locking device 34 toward its rest position.

The temporary locking mechanism also comprises a serrated bar 37 fixed onto the horizontal base 9 of the fixed profile and having a plurality of serrations 38, spaced, for example evenly, in the longitudinal adjustment direction. The locking device 34 comprises a tooth 39 that cooperates with one of the serrations 38 of the serrated bar in the locked position of the locking device.

The locking device 34 is also mounted by means of a hole 40 on a rod 41 fixed through the movable profile and limiting the travel of the locking device 34 in relation to the movable profile.

The locking device 34 is mounted opposite the actuator 31, and cooperates with the latter so that when the actuator 31 is controlled by means of its electrical connection device 32, the actuator 31, acting against the force of the spring 36, moves the locking device 34 from its rest position (FIG. 5) to its locked position (FIG. 7 and FIG. 8).

As shown in FIG. 3, the temporary locking system shown in FIGS. 5, 7 and 8 is coupled with a control system, which will be described in more detail below according to a first embodiment.

Thus, the control system 101 comprises one or more tracking elements 42 arranged, for example evenly spaced, on one of the re-entrant troughs 11 of the fixed profile. The control system can also comprise moreover a reading device 43 complementary to the tracking elements 42, and securely fixed to the movable profile, for example on the web 13 in the example shown. The reading device 43 can for example comprise an electrical connection device 44 for its power supply, so that when the reading device 43 is powered, it is adapted to detect the tracking element 42 arranged directly opposite.

In this first embodiment, the reading device 43 is connected to a central processing unit 45 that will be described below in more detail with respect to FIG. 6.

The central processing unit 45 can for example comprise a processor 46 adapted to detect the read signal supplied by the reading device 43 and compare the result of the reading with personalization data present in a memory 47 of the central processing unit 45. For example, each pair of tracking elements 42 is separate, and the memory 47 comprises, with regard to each of these tracking elements 42, data indicating if, in this position, the temporary locking system 100 must be locked. The central processing unit 45 is thus connected to the actuator 31 by means of its electrical connection device 32 through the web 13 so that if the result of the comparison carried out by the processor 46 is positive, the processor 46 triggers the flow of an electric current to the actuator 31.

The central processing unit 45 can also be connected to an audible alarm device 48 adapted to emit an audible sound if the result of the comparison carried out by the processor 46 is positive. No sound is emitted if the result of the comparison is negative.

If applicable, the central processing unit 45 is coupled to a database of sounds 49 comprising a set of individual sound samples 50 each corresponding for example to a possible occupant of the seat in question. If applicable, a unique database of sounds 49 is distributed over all of the seats, even if certain occupants are not likely to use certain seats.

The central processing unit 45 can also be coupled to an information input interface system 51 adapted to define the data stored in the memory 47. The input interface 51 comprises for example “backwards” 52, “forwards” 53 and “confirm” 54 buttons as well as a display screen 55.

With such an input interface 51, it is possible firstly, using buttons 52 and 53, to scroll through the set of sound data 50 contained in the sound database 49 until the desired sound 50 to be associated in the memory 47 with a position is identified. The latter is confirmed by pressing the “confirm” button 54. Then buttons 52 and 53 are used to navigate among the different possible position-identification positions, each corresponding to a tracking element 42 provided on the fixed profile. By pressing the “confirm” button 54 for the desired position, the previously-selected sound data 50 is assigned to one of the tracking elements 42 in the memory 47. The central processing unit 45, the memory 47 and the interface 51 thus form a system for adjusting the predetermined operating position of the electromagnetic actuator.

The system that has just been described operates as follows. When the occupant wishes to carry out an adjustment of the longitudinal position of the seat proper along the axis X, he unlocks the permanent mechanical locking system by operating the cross-bar 5a. During the relative displacement of the movable profile in relation to the fixed profile in the direction X, the reading device 43 reads a plurality of tracking elements 42 as it passes in front of them. For each of the tracking elements, the read signal transmitted by the reading device 43 is compared with the personalization data comprised in the memory 47. If this comparison is positive, the processor 46 can command the emission of a sound by the audible alarm device 48. If applicable, this sound corresponds to personalized sound data comprised in the database of sounds 49. It is thus possible for the occupant to become aware of whether or not this is his position and, as appropriate, release the cross-bar to re-lock the permanent locking system immediately, or keep the cross-bar 5a engaged and continue scrolling the movable profile seeking his personalized position. It can also be provided for the cross-bar also to be connected to the central processing unit 45 so as to inactivate the temporary locking system in this method of adjustment.

If applicable, the result of the comparison shows that the movable profile is in a position included within a range in which the re-locking of the runner is not allowed, and a sound signal is emitted until it is detected that the movable profile has moved out of said range.

If applicable, the memory 47 contains information relating to the occupant of the seat. This information is for example obtained when the occupant of the seat has used a personalized ignition key to unlock the vehicle. The central processing unit 45 is thus capable of distinguishing, from the different tracking elements 42 that send a read signal corresponding to a potential occupant of the seat, the unique tracking element that corresponds to the current occupant of the seat. Thus, if applicable, the re-locked position is assigned in the memory 47 as the new predetermined position for the occupant in question when the cross-bar 5a is released by the occupant.

Thus, for the adjustment of the longitudinal position of the seat, the spring 36 keeps the temporary locking system in the rest position.

According to another use of the seat, the seatback was tilted forwards, and the seat was pulled forward in order to facilitate access to the space located behind the seat, for example for a three-door vehicle, as shown in FIG. 9a. In this configuration, a holding mechanism maintains the seatback in its folded-forwards position. This can be for example a simple spring, or the hinge mechanism of the seatback is kept locked in the folded-forwards position. Moreover, the holding mechanism maintains the permanent locking mechanism of the runner unlocked. Such holding mechanisms are used as standard in such seats, and do not require further description. Purely for illustration purposes, reference can be made to FR 2 882 537.

If the occupant wishes to bring the seat backwards, during the journey to the rear of the movable profile, each time it is facing a tracking element 42, the reading device emits a read signal that is compared by the processor 46 with information contained in the memory 47. When the result of this comparison is positive, the processor 46 makes the audible alarm system 48 emit a sound that can for example be a personalized sound obtained from the database of sounds 49. If applicable, the occupant can then return the seat to upright, in order to de-activate the holding system. The permanent locking system will re-lock the runner in this position.

If applicable, the memory 47 will also comprise data identifying the current occupant of the seat, and will control the operation of the actuator 31 when the tracking element 42 identified corresponds to this occupant. As shown in FIG. 7, this operation will drive the rotation of the locking device 34 until the tooth 39 engages with one of the serrations 38 of the serrated bar 37. The corresponding position is illustrated in FIG. 9b. This operation by the actuator 31 is only temporary, and lasts for example for five seconds at most, long enough to provide for the holding device to release the tilt lock mechanism and for the user then to return the seatback to upright from its folded position to its nominal use position, shown in FIG. 9c. The rotation of the seatback towards its nominal position, in a manner known per se, triggers the re-locking of the permanent locking mechanism of the runner and the hinge locking mechanism in the nominal position of the seatback. The power supply to the actuator 31 can then cease, so that the locking device 34 returns to its rest position.

According to a second embodiment, as shown in FIG. 10, the tracking element 42 is produced in the form of a housing 55 of insulating material, for example plastic, supported by the vertical wing of the fixed profile. The insulating housing 55 supports a first electrical element 56 electrically connected by means of an electrical connection terminal 57 to an electric generator. The reading device 43 is produced for example integral with the movable profile, comprising an insulating housing 58 that supports a second electrical element 59 adapted to cooperate with the first electrical element 56 in a given relative position of the fixed and movable runner profiles in order to allow an electric current to flow from the terminal 57 to an audible alarm device 48 electrically connected to the second electrical element 59.

It will be noted in particular that the tracking element 42 can in particular, in the present embodiment, be mounted so that it can be moved in relation to the fixed profile in order to adjust the predetermined position in which the actuator is controlled. It is possible in particular to produce the tracking element 42 as a part of a memory shoe 65 that is alternately lockable or unlockable in relation to the fixed profile by means of a second locking system (not shown). Such memory shoe systems are well known to a person skilled in the art, and are in particular described for example in FR 2 778 613.

In the first embodiment, as in the second, an audible alarm device is not necessarily used. In this second embodiment, the actuator can be controlled directly by the reader 43, without using a central processing unit and a memory.

1. A motor vehicle seat runner comprising:
a fixed profile adapted to be fixed to a floor of a motor vehicle,
a movable profile adapted to be fixed to a vehicle seat element that is adapted to receive an occupant, said movable profile being complementary to the fixed profile and movably mounted in relation to the latter in a direction of sliding,
a mechanical locking system of the fixed profile and the movable profile, adapted to alternately adopt an active state in which it prevents the relative movement of said fixed and movable profiles, and an idle state in which it allows said relative movement,
a control device of the mechanical locking system, said control device being adapted to move said mechanical locking system from its active state to its idle state, and
a position memorization system, adapted to prevent movement of the movable profile beyond a predetermined position when the mechanical locking system is in its idle state,
wherein the memorization system comprises:
a locking bar comprising a set of locking reliefs spaced apart in a longitudinal direction, said bar being integral with the fixed profile,
a locking device movably mounted on the movable profile, between a rest position in which it does not cooperate with any of the locking reliefs in order to allow a relative movement of the movable profile and the fixed profile in the longitudinal direction, and a locked position in which it cooperates with a locking relief in order to prevent said relative movement,
a electromagnetic actuator fixed to the movable profile, and adapted to move the locking device to its locked position upon receipt of an actuation command,
a control device electrically connected to the actuator, and adapted to transmit an actuation command to the actuator to prevent the relative movement of the movable profile and the fixed profile beyond said predetermined position.

2. The runner according to claim 1, in which the control device comprises a position detection system adapted to detect a relative position of the fixed profile and the movable profile in the longitudinal direction, said position detection system being electrically connected to the actuator, the control device being adapted to transmit an actuation command to the actuator when it detects said predetermined relative position.

3. The runner according to claim 2, in which the detection system comprises at least one tracking element, fixed to the fixed profile, and a position sensor adapted to detect said tracking element and to transmit to the actuator a signal related to said tracking element.

4. The runner according to claim 3, comprising a plurality of separate tracking elements spaced apart in said longitudinal direction, the control device comprising a programmable memory comprising position personalization information, the control device comprising a central processing unit adapted to compare said signals with said position personalization information and to transmit said actuation command upon positive result of said comparison.

5. The runner according to claim 1, in which the actuator is adapted to move the locking device to its locked position for a period of less than five seconds upon receipt of an actuation command, the actuator comprising a mechanical biasing device adapted to move the locking device to its rest position after said period.

6. The vehicle runner according to claim 1, comprising moreover an adjustment system for adjusting said predetermined position.

7. A motor vehicle seat comprising:
a seat proper,
a seatback, mounted rotatably in relation to the seat proper about a transverse axis at least between a nominal position and a folded-forwards position,
a tilt lock mechanism adapted to selectively adopt an active state in which it prevents the rotation of the seatback in relation to the seat proper about the transverse axis, and an idle state in which it allows said rotation,
a runner according to any one of the previous claims, a seat element chosen from the seat proper and the seatback being mounted on the movable profile,
a holding device adapted to maintain the seatback in its folded-forwards position and to maintain said mechanical locking system of the runner in its idle state at least from a forward position of the movable profile to the predetermined position of the movable profile in relation to the fixed profile when the seatback is in said folded-forwards position, said predetermined position being rearward in relation to the forward position,
the actuator being controlled in said predetermined position of the movable profile, when the seatback is in said folded-forwards position,
the holding device being adapted to allow rotation of the seatback in relation to the proper from the folded-forwards position to the nominal position, and to release the mechanical locking system of the runner in order to place it in its active state in said predetermined position.
